(19) United States
(12) Patent Application Publication
(10) Pub. No.: US 2010/0035656 A1
(43) Pub. Date: Feb. 11, 2010

(54) Delivering Advertisement Messages to a User by the Use of Idle Screens of Mobile Devices with Integrated Sensors

(76) Inventor: Yang Pan, (US)

Correspondence Address: Yang Pan, Shimao Riviera Garden, Wei Fang Rd. (W), Lane 1, Block 9, Unit 8A, Shanghai, 200122, CN

(21) Appl. No.: 12/189,219

(22) Filed: Aug. 11, 2008

(51) Int. Cl. H04M 1/00; G06F 3/033; G06Q 30/00

(52) U.S. Cl. 455/566; 345/158

(57) ABSTRACT

A method is disclosed by the use of an idle display screen of a mobile device to present an advertisement message. An idle screen, which is taken as a blanket screen in the exemplary case for the illustration, is displayed while the device is idling. A plurality of sensors is integrated with the mobile device. The sensors are used to detect the user's action for holding and positioning the device before user's input actions. A message can then be displayed a short period of time before user's input actions to the device. The system requires a minimum amount of additional power consumption for delivering advertisement messages to the user. It allows that multimedia messages are delivered with acceptable power consumption when utilizing of the idle screens. One embodiment employs pressure sensors, which are placed in selected locations on the sidewalls and/or on the surface of the backside of the device. The locations are selected to match the locations on the surface of the device that a user's hand is in touch with when holding the device for a user's input action. Another embodiment employs touch-screen type of sensors to sense a human hand in touch with the device. Further, accelerator-meters and photo-sensors can be placed in or onto the device to detect changes of physical parameters associated with the interaction actions from the user before an advertisement message is displayed.

### CROSS-REFERENCE TO RELATED APPLICATIONS

Not applicable.

### BACKGROUND

1. Field of Invention

This invention relates generally to advertising. More specifically, the invention relates to methods and systems for providing advertisements by the use of idle screens of electronic devices.

2. Description of Prior Art

To provide information and communication services to various users, electronic devices with computing and communication means are widely used today. Many of these electronic devices are kept in a functioning state even when the user is not using the device in order to keep the device in touch with the communication network. Many electronic devices simply display an idle screen while the device is not being used. Many mobile devices display a blanket screen to conserve energy provided by a battery. A typical idle screen for a mobile computing and communication device may include such information as radio signal strength, battery charge level, current date, time of day.

Such displays provide no or little information to the user who, however, has to glance at the display whenever he/she operates the device. It would be desirable to display advertisement messages so that it is nearly guaranteed that the user sees the messages.

U.S. Pat. Nos. 5,913,040, 6,317,789, 6,539,429 to Rakavy et al disclosed prior arts to utilize idle screen of a mobile device to display advertisement messages, which are delivered to the user's device without user's notification. The messages are displayed preferably as a screen saver. U.S. Pat. No. 6,363,419 to Martin, Jr. et al disclosed a method to display useful or commercial information on an idle screen. The idle content screen is switched to a default display screen when a user's input action is received. The default display screen is the gateway for the user to navigate to various application menus of the mobile device. US patent application 2004/0077340 by Forsyth and the application 2006/0156256 by Lee disclosed similar arts to use idle screens for displaying commercial information with the user's programmability on the displayed contents. In U.S. Pat. No. 7,369,864 to Vaananen, an art is disclosed by using of electronic short messaging method to deliver advertisement messages. The user is shown the message automatically, and he or she may delete it or receive further information on it with one single press of a dedicated key.

The disadvantages of prior arts are related to increased power consumption if the idle screen is somehow over-utilized. Although significant progress has been made with regards to the battery technology, the power consumption continues to be a key challenge for mobile devices. Therefore, a blanket idle screen in many occasions is displayed when the device is in idle status to save power consumption to prolong the usage of the battery. The use of the idle screen to display commercial messages will short the battery usage time and is less desirable, in particularly, if the messages include bright colorful pictures and multimedia audio/video files.

The utilization rate of a mobile device by an average user is typically low. It is very often that the device is placed into one's pocket or into any other containers such as, for example, a handbag. It is desirable to detect a user's action for grasping the device and holding it at a right position before the user operates it. The messages can then be displayed just before the user's input actions. By such an inventive method, the idle screen can be used to deliver advertisement messages without consuming significant amount of battery power.

Accordingly, it is an object of the present invention to provide a method for delivering advertisement messages displayed on an idle screen of a mobile device while it requires little additional battery power.

### SUMMARY OF THE INVENTION

To more effectively use the display screen during idle time of mobile devices, the present invention introduces an idle content display system. The device displays a blanket screen while in the idle status. The blanket screen is employed in a preferred embodiment although an idle screen can be used to display simple text messages. The inventive features of the present invention include a means to display an advertisement message on the screen in a short period time before the user operates the input devices of the mobile device. Various embodiments are disclosed with various means of integrating sensory systems with the mobile devices to accomplish the above mentioned objectives.

In one embodiment, a plurality of pressure sensors is placed under the surfaces of sidewalls of the mobile device. The locations of the placement are selected in a way that they are most likely touched by the user's hand during the operation of holding the device. In another aspect of the present invention, the pressure sensors can be placed under the surface of the backside of the device. The locations of the placement again can be selected that they are most likely to be touched by the palm or fingers of the user's hand.

In another embodiment, a plurality of touch-screen type of sensors is placed in the similar locations as the pressure sensors mentioned above. The touch-screen type of sensors has been used in the mobile device as touch-screen type of displays. In one of the implementations, a human hand is capacitive and it alters the capacitance of the sensor when in touch. In such an implementation, capacitive sensors fit the size of the sidewall of the mobile device are mounted on the surfaces of the sidewalls. It may looks like that smaller size touch-screens are placed on the sidewalls of the device.

In yet another embodiment, one or a plurality of accelerator-meters can be used to detect the movement of the mobile device. The sensors can detect the changes of the status of a mobile device from still to a specific movement such as, for example, the user picks up the device that was placed on a desk. In such a circumstance, the accelerator-meter detects a signal associated with position and orientation changes of the device. Further, the device might be placed in the user's pocket and the user is moving around. A user's action to pickup the device from the pocket and to position it for a further input action generates detectable signals from the sensors when the orientation of the device is changed associated with the user's action.

In yet another embodiment, one photo-sensor is placed onto the top portion of the front side and another photo-sensor is placed onto the top portion of the backside of the device. When the device is placed in one's pocket or in a container such as, for example, in a handbag, the photo-sensors detect a low-output signal associated with the darkness of the ambient. When the device is pulled out from the container by the user's hand, the photo-sensors detect a change of the brightness of the ambient and generate signals. In another exemplary aspect, the device is placed on a wooden table and one of the photo-sensor detects low signal and another detects high signal associated with the brightness of the ambient. When the device is removed by the user from the table, both photo-sensors detect the brightness of the ambient and generate signals.

The embodiments described above can be used in certain combinations to improve the reliability of the detection. Thus the idle screen of the device can be used with minimum added power consumption. The messages are presented only when the sensory system detects the user's action to hold and to position the device for the user input actions. Because of the inventive method, it opens door for displaying a multiple media message to the user with well controlled power consumption when using idle screens to present advertisement messages. Otherwise, it would be impractical to display multimedia message by using the idle screens. The power consumption would prohibit the implementation of presenting multimedia messages to the user by the use of the idle screen of the mobile device.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of a mobile device including sensors and a sensor data management unit.

FIG. 2 is a flow diagram of presenting advertisement messages employing an idle screen of a mobile device by the use of integrated sensors to sense the user's actions of holding and positioning the device for the user's input actions.

FIG. 3A is a schematic diagram of an embodiment employing pressure sensors to detect the user's action of holding the device. The pressure sensors are placed at selected positions of the sidewalls of the mobile device.

FIG. 3B is a schematic diagram of an embodiment employing pressure sensors to detect the user's action of holding the device. The pressure sensors are placed at selected positions of the backside of the mobile device.

FIG. 3C is a schematic diagram of an embodiment employing large area capacitor pressure sensors to detect the user's action of holding the device. The pressure sensors are placed onto the right and left sidewalls of the mobile device. At least one of the electrodes forms a part of the device house.

FIG. 4A is a schematic diagram of an embodiment employing touch-screen type of sensors to detect the user's action of holding the device. The sensors are placed at selected positions of the sidewalls of the mobile device.

FIG. 4B is a schematic diagram of an embodiment employing touch-screen type of sensors to detect the user's action of holding the device. The sensors are placed at selected positions of the backside of the mobile device.

FIG. 5 is a schematic diagram of an embodiment employing accelerator-meters to detect the user's action of holding and positioning the device. The integrated accelerator-meters are capable to detect the changes of the device position and orientations as shown in the figure.

FIG. 6 is a schematic diagram of an embodiment employing photo-sensors to detect the user's action of holding and positioning the device. The sensors are placed onto the front-side and back-side surfaces, respectively.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

The present system comprises at least one advertising server operated by an advertisement broker and at least one mobile device with a display screen and a user input device. A mobile computing and communication device is used as an exemplary case in this disclosure. The method, however, applies to all mobile devices with a display screen, a user input device and a communication means, which are operated with a battery to supply power. The server and the mobile device are connected by a wireless communication network, which can be a wireless internet or a telephony network in our preferred embodiment. The server is also connected to a plurality of advertisers who subscribe to the advertising broker for delivering the advertisement messages to users of mobile devices.

A plurality of advertisement messages is sent by the server to the mobile device. The received messages are stored in a file storage system of the mobile device and are ready to be presented to the user. When a display screen is idle, a blanket screen as an exemplary illustration is displayed to conserve the power from the battery. The screen is in an idle status if the device does not receive a user's input action and does not receive a calling message from the communication network.

In various embodiments of the invention, advertisements may include text, graphics, video, audio and multimedia messages. It should be appreciated that while advertisement messages are used herein as exemplary embodiments of the invention, any document may be used in accordance with the various embodiments. For instance, documents such as advertisements, content pages, search results, emails, IM messages, audio content or files, video contents or files, other data or applications that may reside on one or several of computer systems, or other definable concepts or content may be used. Thus although the use of advertisement messages are described herein as examples, other documents such as web pages may be targeted to viewers and displayed in accordance the various embodiments, e.g. as described herein with respect to advertisement messages.

It should be understood that an advertisement message as used herein may comprise audio and/or video signals, static and/or dynamic images, graphics, video, film, or other content that relate to one or more products, services, and/or entities, such as commercial entities. Advertisement messages may also comprise various visual features, including animation, sound etc., and may include text, such as in a text advertisement. Thus, the term “advertisement message” is used herein in its broadest sense to include any content or object intended for observation, use, or consumption by one or more persons for the purpose of marketing or promoting a product or service. While, advertisement messages are used for exemplary purpose, it should be understood that any audio and/or video content, such as television programming, may be used with the systems and methods described herein.

The term “idle screen” refers to the screen displayed when the mobile device is switched on and therefore capable of receiving a voice call or other forms of messages. The idle screen is the screen which is displayed when the user is not navigating to a particular function, nor actively using particular application, or a messaging application. In many cases, the idle screens are blanket screens to conserve energy. The present invention is with an object to utilize the idle screen to display advertisement messages with minimum additional power consumption.

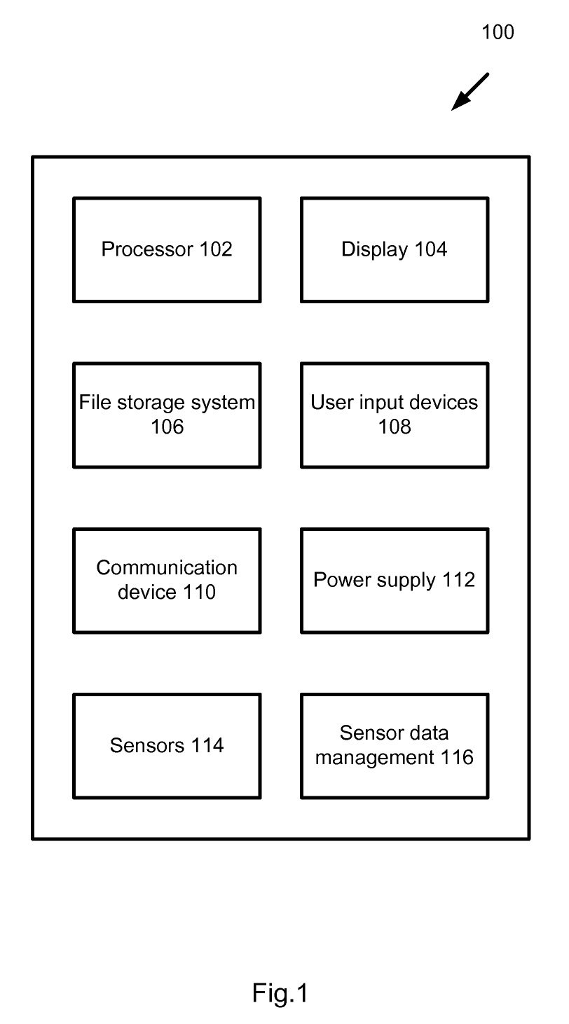

We take a mobile computing and communication device as an exemplary case to illustrate the present invention. As shown in FIG. 1, the mobile device 100 may comprise a processor 102 to control operations of the device, a display screen 104, such as, for example, a Liquid Crystal Display (LCD) screen and a file storage system 106. The file storage system 106 is typically a semiconductor flash memory device or a plurality of flash memory devices or a magnetic storage means as a hard disk driver. The file storage system may also include a cache to improve the data access time. The mobile device 100 further comprises a user input device or devices 108 as keys, touch pads or a rotational user interface as used in iPod from Apple Inc Cupertino Calif. The user input device can be integrated at least partially with the display screen in a specific implementation related to touch-screen type of display. A touch-screen is a display which can detect the location of touches within display area, usually performed either with the human hand or a stylus. The device 100 also includes a communication device module 110 to connect to the communication network. The communication network can take forms as a telephony network or the internet In one implementation, the mobile device is GSM mobile station. In other implementations, the mobile devices may be a UMTS, WAP, Teldesic, Inmarsat, Iridium, GPRS, CDMA, WCDMA mobile station. The mobile device may be connectable to a wireless internet network. The device is powered by a power supply 112 such as a battery, which is typically a re-chargeable battery. Further, the device includes a plurality of sensors 114 to detect the user's holding and positioning actions of the mobile device and a sensor data management unit 116 with functions such as, for example, to convert detected analog signals from the sensors into digital signals.

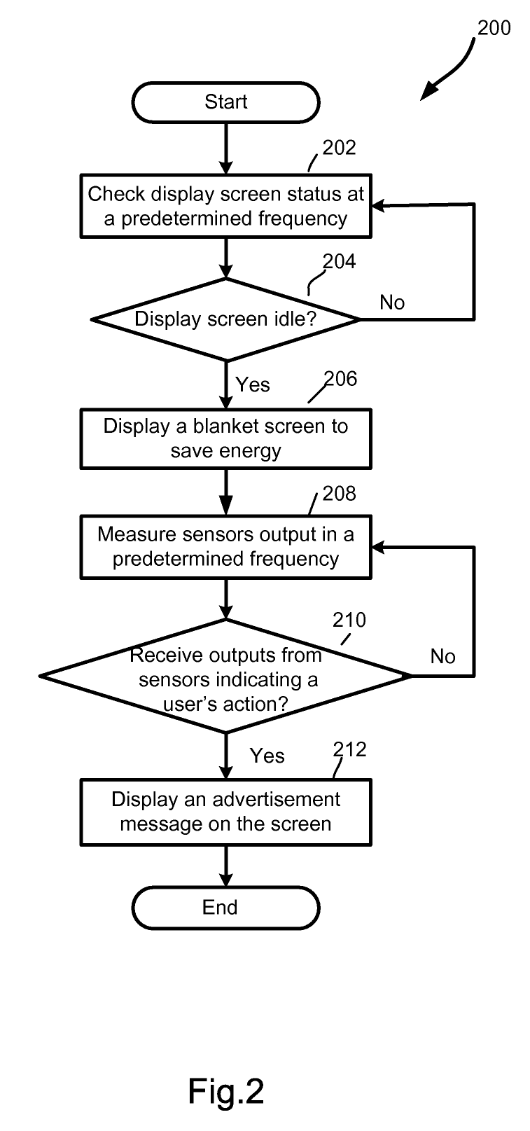

FIG. 2 is a flow diagram describing an embodiment for delivering and presenting advertisement messages to the user by the use of an idle screen. The process 200 starts by a step 202 that the server delivers advertisement messages to the mobile device. The processor checks the status of the device at a predetermined frequency in a step 204. If the device is detected in exceeding of a predefined time without the user's input actions, a blanket screen is displayed in a step 206. A blanket screen helps the mobile device powered by a battery to conserve the energy. In a step 208, the processor controls to receive the measurement results of the sensors by the sensor data management unit in a predetermined frequency. The collected data are then processed and analyzed by the sensor data management unit and the processor if required. In a step 210, if the output of sensors is in exceeding of a predetermined threshold, which is in accordance with a user's action for holding and positioning the device, the processor sends a control signal to the file system and an advertisement message is displayed to replace the blanket screen in a step 212. The user can view the message before his or her input actions and then decides to view more detailed messages further or to remove the message and to navigate through a default display screen.

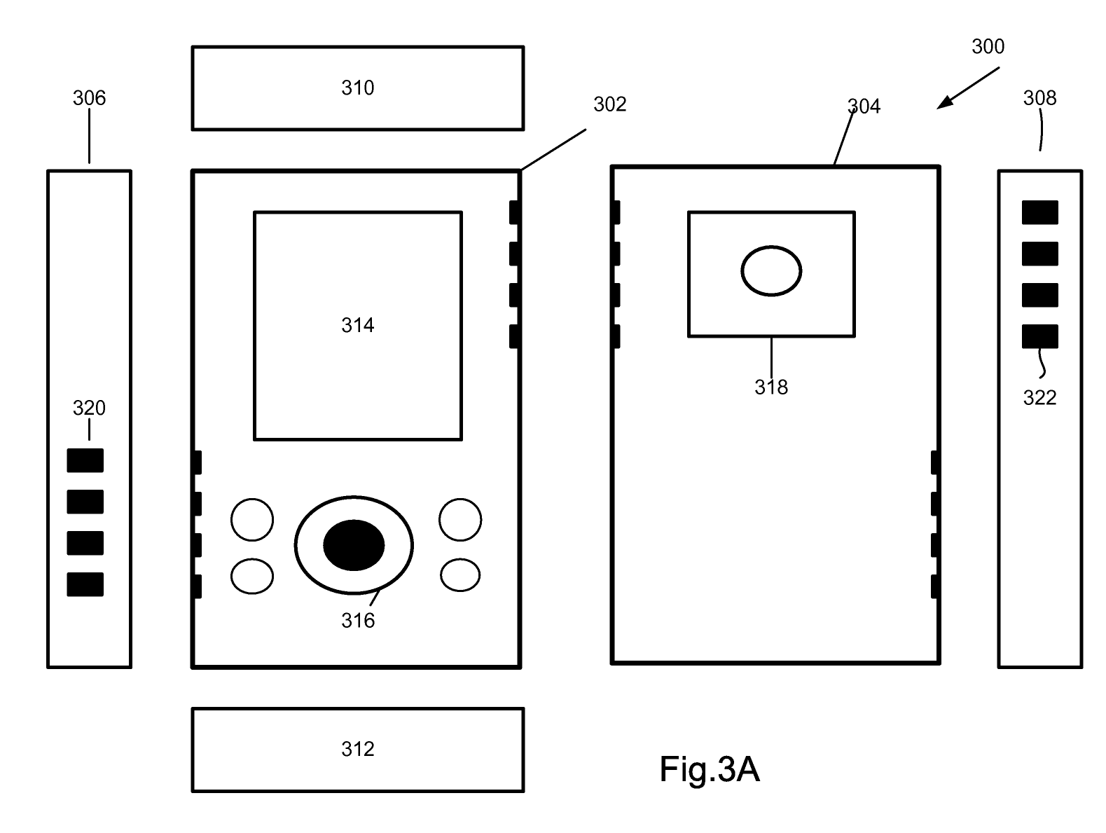

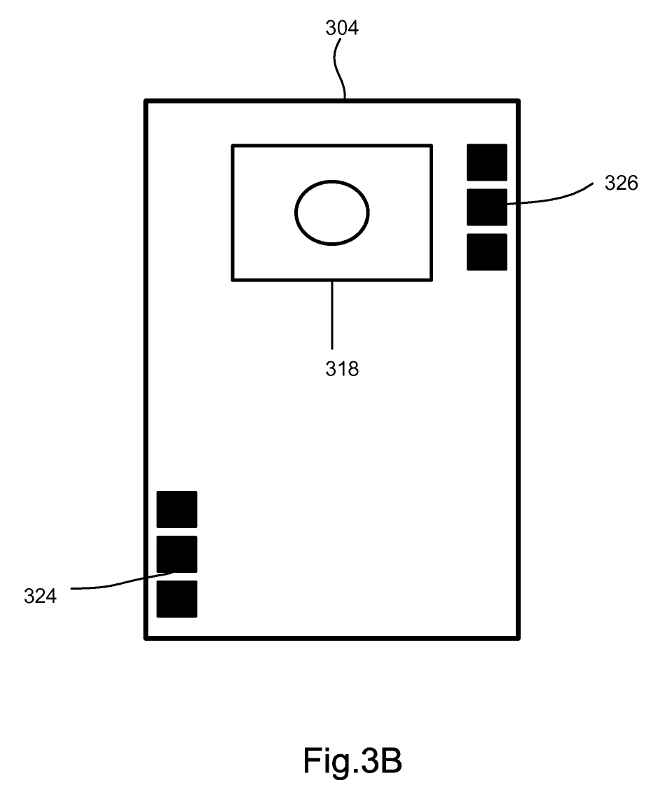

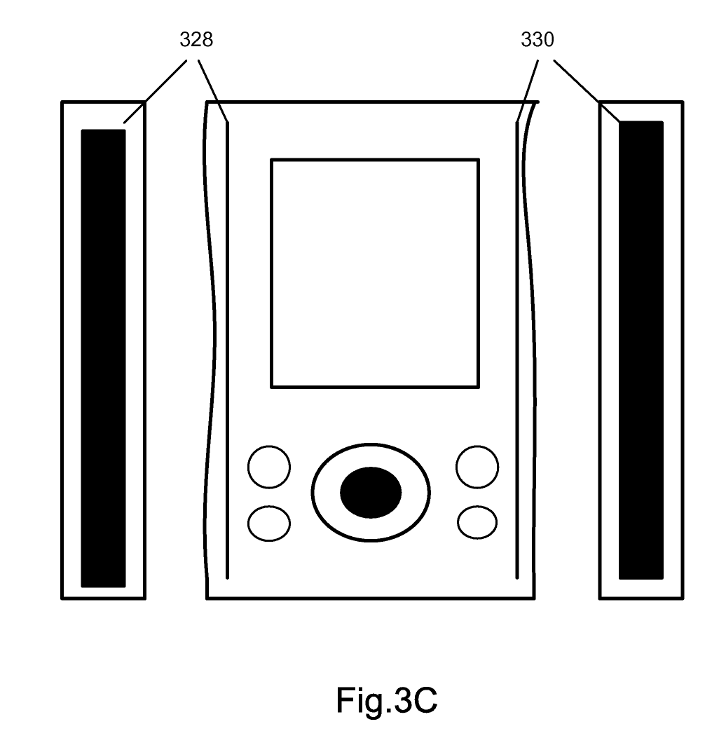

FIG. 3A is a schematic diagram of an embodiment employing pressure sensors to detect the user's actions of holding and positioning of the device. As shown in FIG. 3A, the mobile device 300 includes a house that consists of a front surface 302 for a display screen 314 and a user input device 316, a back surface 304 with a digital camera 318 in some implementations, a right sidewall 306 and a left sidewall 308, a top sidewall 310 and a bottom sidewall 312. Pressure sensors 320 are placed at selected positions of the left sidewall 308 and pressure sensors 322 are placed at the selected positions of the right sidewall 306. The selected positions match touching locations for a user's hand. The number of sensors and positions of placement can be selected to ensure that at least one sensor is in touch with the user's hand. In such an implementation, the pressure sensors detect the user's holding and positioning actions and the signals are processed by the sensor data management unit and are transmitted to the processor through a data-bus. The processor receives the signals and compares with a predetermined threshold and to make a decision if a control signal is sent out to display an advertisement message.

FIG. 3B is a schematic diagram of another embodiment by placing pressure sensors onto the backside of the device. The two groups of sensors 324 and 326 are placed at the locations to be touched by the user's palm or fingers when he or she is holding the device. Sensors can be placed onto the sidewalls and the backside of the device concurrently to improve the reliability of the method for detecting the user's action for holding and positioning the device.

In the present invention, the pressure sensors may be silicon-based sensors manufactured by an Integrated-Circuit-based process. The cost of silicon pressure sensors has been reduced significantly in recent years and the placement of the sensors into mobile devices is becoming an affordable means. In another aspect of the present invention as shown in FIG. 3C, the house of mobile device can be used a part of the sensors to detect a human interaction induced pressure. For example, large capacitors 328 and 330 can be placed along the sidewalls of the device. The surface materials may comprise one electrode of the capacitor. When the pressure is applied by a human hand in touch with the device, the sidewall materials containing at least one of the electrodes of the capacitor are deformed slightly as shown in FIG. 3C, which is exaggerated to illustrate the invention. The changes of the capacitance can be detected by electronic circuits integrated with the device as well as connected to the sensing capacitors. It should be noted that the capacitor do not need to be in a regular shape as shown in the figure. Functional buttons can still be placed along the sidewalls of the device as long as the variation of the capacitance by a human hand's action for holing the device can be detected. In an alternative way, at least one of capacitors can be placed at the backside of the device to sense a force applied by a palm or fingers of the user.

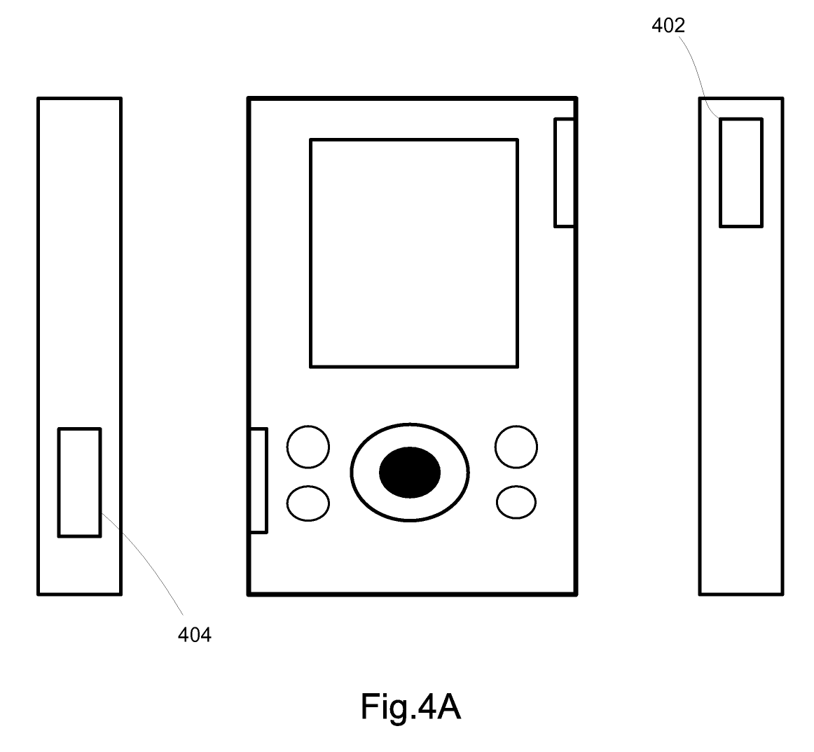

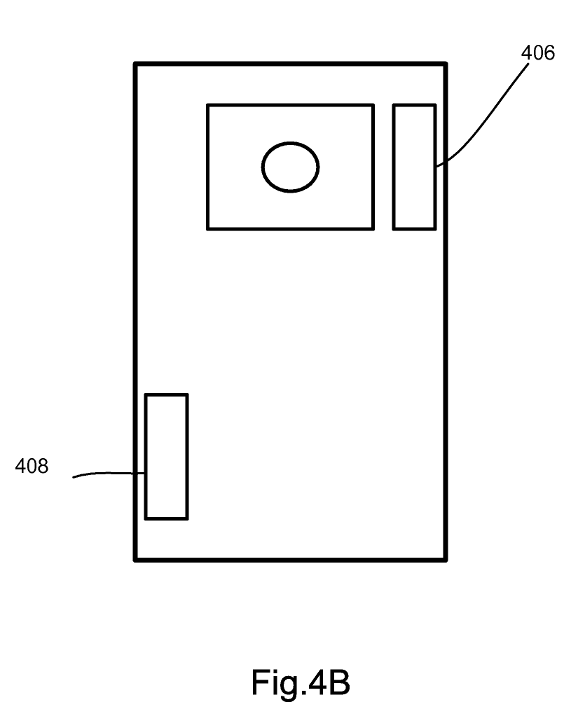

In another embodiment, touch-screen type of sensors can be used to detect a human hand in touch with the device. The principle has been applied to the touch-screen type of display, which has gained significant popularity in recent years. In one implementation, the touch-screen type of sensors is a capacitive sensor. A human hand is a capacitor from a point of view of electrical components. The charge stored in a sensing capacitor is changed when a human hand is in touch with the sensing capacitor. In one aspect of the present invention, as shown in FIG. 4A, A touch-screen type of sensor 402 is placed on the top portion of right sidewall and sensor 404 is placed on the bottom portion of left sidewall. The placement of the sensors reflects the user's hand holding positions of the device. In such an implementation, the device looks like to have two smaller touch-screen windows on the sidewalls. In another implementation as shown in FIG. 4B, the touch-screen type of sensors 406 and 408 can also be placed on selected positions of the backside of the device to sense the user's palm or fingers.

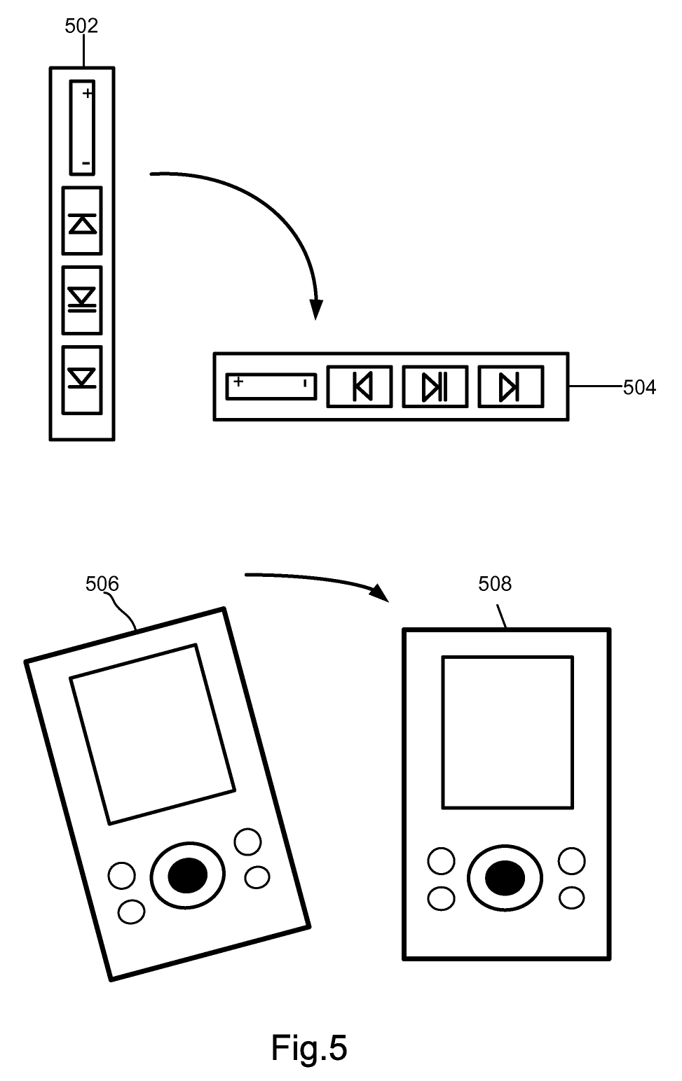

In another embodiment of the present invention, accelerator-meters are applied to detect the user's action for holding and positioning the mobile device. When a mobile device is not in use by the user, it may be placed on a substrate or inside a container such as, for example inside one's pocket. The device may be in still or be moved around with the carrier such as, for example the user. In a user's action to grasp the mobile device and to hold it and to position it for a user's action, the device has typically the movements associated with the change of orientation from vertical to horizontal one as shown in FIG. 5 from a position 502 to a position 504. Such movement is unlikely when a mobile device is placed in a user's pocket without a user's intended interaction. The user's action for holding and positioning the mobile device is also typically accompanied by the change of the device orientation to position the device towards the user's face as shown in FIG. 5 from a position represented by 506 to a position represented by 508. In the present invention, accelerator-meters are placed in the mobile device to detect such position and orientation changes and, consequently, to correlate the measurements with the user's actions for holding and positioning the device.

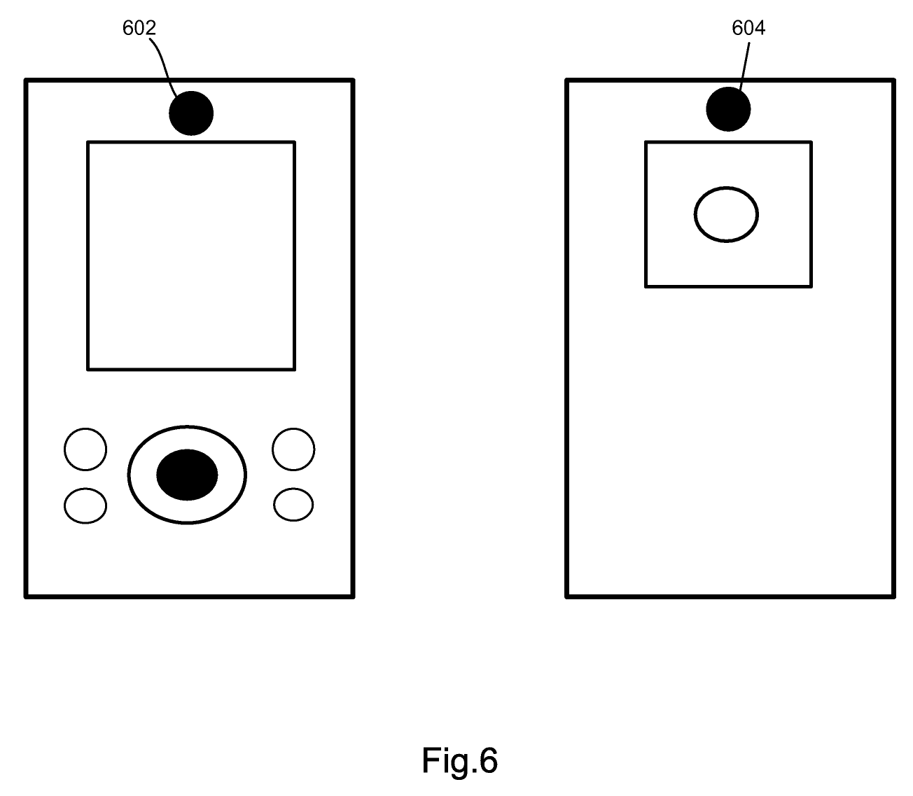

In yet another embodiment of the present invention, a pair of photo-sensors is applied to detect the changes of the illumination level of the ambient of the mobile device and to correlate such changes to the user's action for holding and positioning the device for the user's input actions. As shown in FIG. 6, one photo-sensor 602 is placed onto the top portion of the front surface of the device and another photo-sensor 604 is placed onto the top portion of the backside surface. When the device is not in use such as, for example, it is placed in one's pocket, both photo-sensors detect low ambient illumination level. When the device is placed on top of a substrate such as, for example on the surface of a wooden table, at least one of the photo-sensors detects low ambient illumination level. When the user pulls the device from one's pocket or grasps the device from a table, both photo-sensors detect the high ambient illumination level when the ambient is bright. The embodiment does not apply to the cases when the ambient is dark such as the user employs the device in a dark room or at outdoor at night. In such a circumstance, both photo-sensors would detect the low ambient illumination level

The embodiments described above can be used in certain combinations to improve the reliability of the detection. For example, accelerator-meters and photo-sensors can be integrated with the device. Two methods can be used concurrently and the data collected is analyzed by the processor to reach a more reliable decision to present an advertisement message. For example, in the case that the ambient is dark, the processor can take the data from accelerator-meters and photo-sensors and can make a decision by taking into the consideration of the time of the day and the location of the user if a GPS function is integrated.

It should be noted that the present invention is targeted to deliver the advertisement messages to a user while conserving the power of the device as much as possible. In an occasional case, if the message would be presented by a wrong decision from the processor and the device fails to receive the user's input action after a predetermined period of time, the device switches to the blanket screen. The power wasted by such an occasional malfunction would be very limited.

The present invention is targeted to provide means for sensing the user's actions for holding and positioning a mobile device and to present an advertisement message just before the user's input actions. The invention can be extended to other applications related to mobile devices. For example, a mobile phone switches from a blanket device to a default display screen after sensing that a user initiates the action of holding the device. Further, a media player may display a first level of user interface from a sleep mode when the user's action of holding the device is detected.

1. A method of presenting an advertisement message to a user using at least one mobile device integrated with a sensory system, the method comprising:
displaying an idle screen and;
sensing by said sensor the user's actions to get the device ready for the user's input actions and;
displaying at least one message on a display screen.

2. The method as recited in claim 1, wherein said mobile device comprising:
a display screen providing means to display messages and;
a user input device providing means to receive a user's input and;
a processor providing means to control operations of the device and;
a power supply providing power for the operations of the device.

3. The method as recited in claim 1, wherein the method further comprising:
viewing the displayed message by said user and/or;
removing the displayed message by an user's input action.

4. The method as recited in claim 1, wherein said user's actions to get the device ready including:
holding the device by said user's hand and;
positioning the device in a position with an orientation that said user can actuate the input device and can view the display screen.

5. The method as recited in claim 1, wherein said idle screen including a blanket screen.

6. The method as recited in claim 1, wherein said sensory system including one or a plurality of pressure sensors.

7. The method as recited in claim 1, wherein said sensory system including one or a plurality of touch-screen type of sensors.

8. The method as recited in claim 1, wherein said sensory system including one or a plurality of accelerator-meters.

9. The method as recited in claim 1, wherein said sensory system including one or a plurality of photo-sensors.

10. A mobile device provides means to sense a user's action for holding and positioning the device for user's input actions, the device comprising:
a display screen providing means to display messages and;
a user input device providing means to receive a user's input and;
a processor providing means to control operations of the device and;
a power supply providing power for the operations of the device and;
a sensory system to provide means for sensing and;
a data management unit for said sensory system.

11. The device as recited in claim 10, wherein said sensory system including one or a plurality of pressure sensors located in sidewalls and/or the backside of the device.

12. The device as recited in claim 10, wherein said sensory system including one or a plurality of pressure sensors based upon the capacitance change by applied pressure, of which at least one electrode is a part of the device housing.

13. The device as recited in claim 10, wherein said sensory system including one or a plurality of touch-screen type of sensors located in sidewalls and/or backside of the device.

14. The device as recited in claim 13, wherein said touch-screen type of sensors including sensors used in prior arts related to the touch-screens.

15. The device as recited in claim 10, wherein said sensory system including one or plurality of accelerator-meters providing means to sense movements of the device associated with a user's operation of holding and positioning the device for the user's input actions.

16. The device as recited in claim 10, wherein said sensory system including one or plurality of photo-sensors providing means to sense the ambient brightness and to associate the measurements with the user's operation of holding and positioning the device for the user's input actions.

17. The device as recited in claim 10, wherein said sensory system including at least one photo-sensor located in the front side of the device and at least one photo-sensor located in the backside of the device.

18. The device as recited in claim 10, wherein said sensory system comprising a plurality of sensors including any combination of said pressure sensors, said touch-screen type of sensors, said accelerator-meters and said photo-sensors.

19. A method of sensing user's actions to get a mobile device ready for the user's operation, the method comprising:
holding the device by a user's hand and;
sensing the user's actions by a sensory system integrated with said mobile device and;
receiving signals by a processor and;
generating a control signal by the processor.

20. The method as recited in claim 19, wherein said sensory system senses human interaction with the device, the method comprising:
sensing human hand induced pressure and/or;
sensing human hand induced capacitance change and/or
sensing device position and orientation changes associated with human actions to the device and/or
sensing ambient brightness changes associated with human actions to the device.

21. The method as recited in claim 19, wherein said sensory system including one or plurality of sensors is placed at selected positions of a device house to maximize received signals from the user's interaction with the device.
